(19) United States
(12) Patent Application Publication
(10) Pub. No.: US 2026/0157436 A1
(43) Pub. Date: Jun. 11, 2026

(54) ATOMIZER AND ELECTRONIC ATOMIZATION DEVICE

(71) Applicant: SHENZHEN FIRST UNION TECHNOLOGY CO., LTD., Shenzhen, Guangdong (CN)

(72) Inventors: Liangjie SU, Shenzhen, Guangdong (CN); Ruilong HU, Shenzhen, Guangdong (CN); Wenqiang HUANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/126,885

(22) PCT Filed: Nov. 2, 2023
(86) PCT No.: PCT/CN2023/129401

§ 371 Date: May 2, 2025

(30) Foreign Application Priority Data
Nov. 4, 2022 (CN) 202211390555.2
Nov. 4, 2022 (CN) 202222963221.1

(51) Int. Cl. A24F 40/44; A24F 40/10; A24F 40/42; A24F 40/46; A24F 40/48; H05B 3/22

(52) U.S. Cl. CPC A24F 40/44; A24F 40/10; A24F 40/42; A24F 40/46; A24F 40/48; H05B 3/22

(57) ABSTRACT

An atomizer and an electronic atomization device are provided. The electronic atomization device includes an atomizer and a power supply mechanism. The atomizer includes a proximal end and a distal end facing away from each other in a longitudinal direction, an air inhalation port, a liquid storage cavity, a porous body, a through hole, and a heating element. The air suction port is located at the proximal end. The liquid storage cavity is configured to store a liquid substrate. The porous body includes a first end close to the proximal end and a second end close to the distal end. The through hole includes a first section close to the first end and a second section close to the second end. A cross-sectional area of the second section at the second end is greater than a cross-sectional area thereof close to the first section.

### CROSS-REFERENCE TO RELATED APPLICATIONS

This application claims priority to Chinese Patent Application No. 202222963221.1, filed with the China National Intellectual Property Administration on Nov. 4, 2022 and entitled “ATOMIZER AND ELECTRONIC ATOMIZATION DEVICE”, and to Chinese Patent Application No. 202211390555.2, filed with the China National Intellectual Property Administration on Nov. 4, 2022 and entitled “ATOMIZER AND ELECTRONIC ATOMIZATION DEVICE”, which are incorporated herein by reference in their entireties.

### TECHNICAL FIELD

Embodiments of the present invention relate to the field of atomization technologies, and in particular, to an atomizer and an electronic atomization device.

### BACKGROUND

A heating component is built in an atomizer of an electronic atomization device, and generates heat through power supply of a battery, to volatilize a liquid substrate near a heating member, to form an aerosol. When the aerosol formed by the liquid substrate in a liquid storage tank of the atomizer is inhaled out, negative pressure is formed in the liquid storage tank, and air compensation is needed for pressure balance.

Currently, a cylindrical ceramic atomizer on the market usually adopts a structure form of ceramic wrapped by cotton, that is, cotton is wrapped on an outer surface of a cylindrical ceramic heating member for liquid guiding and liquid locking. The process cannot achieve automatic assembly, and manual assembly brings poor stability during production. As a result, product consistency is low, atomization efficiency is low, a total particulate matter (TPM) is unstable, a pasty smell or liquid leakage is easily generated, and a taste is reduced.

However, in a conventional ceramic core structure without being wrapped by cotton, after inhalation, an aerosol often forms condensates after cooling, which accumulate in central hole of the ceramic, resulting in a problem of hole clogging and poor user experience.

### SUMMARY

A main technical problem resolved in this application is to provide an atomizer and an electronic atomization device, to resolve a problem that holes inside the porous body are clogged due to condensation of a cold liquid.

In order to resolve the foregoing technical problem, a first technical solution adopted in this application is as follows: An atomizer is provided. The atomizer includes a proximal end and a distal end facing away from each other in a longitudinal direction, an inhalation port, a liquid storage cavity, a porous body, a through hole, and a heating element. The inhalation port is located at the proximal end. The liquid storage cavity is configured to store a liquid substrate. The porous body is in fluid communication with the liquid storage cavity to receive or absorb at least part of the liquid substrate. The porous body includes a first end close to the proximal end and a second end close to the distal end. The through hole includes a first section close to the first end and a second section close to the second end. A cross-sectional area of the second section at the second end is greater than a cross-sectional area thereof close to the first section. The heating element is integrated on the porous body and arranged adjacent to the through hole, so as to heat at least part of the liquid substrate of the porous body to generate an aerosol. The heating element is arranged to at least partially surround the first section and avoid the second section.

A second technical solution adopted in this application is as follows: An atomizer is provided. The atomizer includes a liquid storage cavity, an atomization assembly, at least one inhalation port, an air inlet, and an airflow channel. The liquid storage cavity is configured to store a liquid substrate. The atomization assembly is configured to atomize the liquid substrate to generate an aerosol. The airflow channel is located between the air inlet and the inhalation port. The air inlet, the inhalation port, and the airflow channel are arranged to define an airflow path from the air inlet to the inhalation port through the atomization assembly, to transmit the aerosol to the inhalation port. The atomization assembly includes a porous body and a heating element. The porous body is in fluid communication with the liquid storage cavity to receive or absorb at least part of the liquid substrate. The porous body includes a through hole surrounding or defining at least part of the airflow channel. The through hole includes an inlet end configured for air to enter, an outlet end configured to output an aerosol, a first section close to the outlet end, and a second section close to the inlet end. At least part of a cross-sectional area of the second section decreases in a direction toward the first section. The heating element is integrated on the porous body and arranged adjacent to the through hole, so as to heat at least part of the liquid substrate of the porous body to generate an aerosol. The heating element is arranged to at least partially surround the first section and avoid the second section.

A third technical solution adopted in this application is as follows: An atomizer is provided. The atomizer includes a proximal end and a distal end facing away from each other in a longitudinal direction, a liquid storage cavity, a first tubular element, a heating element, a porous body, and an elastic element. The liquid storage cavity is configured to store a liquid substrate. The first tubular element at least partially extends within the liquid storage cavity in the longitudinal direction of the atomizer. The heating element is located in the first tubular element, and is configured to heat the liquid substrate to generate an aerosol. The porous body is located in the first tubular element and constructed to extend in an axial direction of the first tubular element. The porous body includes a first portion and a second portion arranged in sequence in the axial direction of the first tubular element. The first portion at least partially surrounds the heating element, so as to at least partially avoid the heating element at the second portion. The elastic element at least partially elastically abuts between the first tubular element and the second portion. The first tubular element is elastically coupled to the second portion at least through the elastic element, to cause the porous body to be retained in the first tubular element.

A fourth technical solution adopted in this application is as follows: An atomizer is provided. The atomizer includes a proximal end and a distal end facing away from each other in a longitudinal direction, an inhalation port, a liquid storage cavity, a porous body, a through hole, and a heating element. The inhalation port is located at the proximal end. The liquid storage cavity is configured to store a liquid substrate. The porous body is in fluid communication with the liquid storage cavity to receive or absorb at least part of the liquid substrate. The porous body includes a first end close to the proximal end and a second end close to the distal end. The through hole runs through or extends to the second end from the first end of the porous body. The through hole includes a first section close to the first end and a second section close to the second end. At least part of a cross-sectional area of the second section is greater than a cross-sectional area of the first section. The heating element is integrated on the porous body and arranged adjacent to the through hole, so as to heat at least part of the liquid substrate of the porous body to generate an aerosol. The heating element is arranged to avoid the second section.

A fifth technical solution adopted in this application is as follows: An atomizer is provided. The atomizer includes a proximal end and a distal end facing away from each other in a longitudinal direction, an inhalation port, a liquid storage cavity, a porous body, a heating element, and a first holding element. The inhalation port is located at the proximal end. The liquid storage cavity is configured to store a liquid substrate. The porous body is in fluid communication with the liquid storage cavity to receive or absorb the liquid substrate, and defines a through hole running through the porous body. The heating element is integrated on the porous body and arranged adjacent to the through hole, so as to heat at least part of the liquid substrate of the porous body to generate an aerosol. The first holding element is located between the porous body and the distal end, so as to carry an aerosol condensate in the through hole. The first holding element is provided with at least one flow guide structure, and the flow guide structure is arranged to extend from the first holding element toward the through hole, and is configured to guide the aerosol condensate in the through hole toward the first holding element.

A sixth technical solution adopted in this application is as follows: An electronic atomization device is provided. The electronic atomization device includes the atomizer described above and a power supply mechanism configured to supply power to the atomizer.

Beneficial effects of this application are as follows: Different from the prior art, in the atomizer provided in this application, the through hole runs through or extends to the second end from the first end of the porous body, the through hole includes the first section close to the first end and the second section close to the second end, and the cross-sectional area of the second section at the second end is greater than the cross-sectional area thereof close to the first section. When the aerosol inside the porous body is condensed, the aerosol can flow out downward along an outer periphery of the second section of the through hole, so as to avoid impact on an atomization effect as a result of the porous body being clogged.

### BRIEF DESCRIPTION OF THE DRAWINGS

One or more embodiments are exemplarily described with reference to drawings corresponding to the embodiments, but the exemplary descriptions do not constitute a limitation on the embodiments. Elements in the drawings having same reference numerals represent similar elements. Unless otherwise particularly stated, the figures in the drawings are not drawn to scale.

FIG. 1 is a three-dimensional schematic structural diagram of an electronic atomization device according to an embodiment of this application.

FIG. 2 is a three-dimensional schematic structural diagram of an atomizer of the electronic atomization device shown in FIG. 1.

FIG. 3 is a schematic structural cross-sectional view of the atomizer shown in FIG. 2.

FIG. 4 is a schematic structural cross-sectional view of a porous body of the atomizer shown in FIG. 3.

FIG. 5 is a schematic structural cross-sectional view of the porous body of the electronic atomization device according to another embodiment of this application.

FIG. 6 is a partial schematic enlarged view of the atomizer shown in FIG. 2.

FIG. 7 is a three-dimensional schematic structural diagram of the porous body of the atomizer shown in FIG. 2.

FIG. 8 is a partial schematic structural cross-sectional view of the atomizer shown in FIG. 2 in another embodiment.

FIG. 9 is a partial schematic enlarged view of the atomizer shown in FIG. 8.

FIG. 10 is a three-dimensional schematic structural diagram of a first holding element of the atomizer shown in FIG. 8.

FIG. 11 is a three-dimensional schematic structural diagram of a second holding element of the atomizer shown in FIG. 8.

Reference Numerals: 1000. Electronic atomization device; 100. Atomizer; 200. Power supply mechanism; 1. Proximal end; 2. Distal end; 3. Inhalation port; 4. Liquid storage cavity; 5. Porous body; 6. Through hole; 7. Heating element; 8. First tubular element; 9. Elastic element; 11. Suction nozzle assembly; 12. Housing, 13. Base assembly; 14. Air inlet; 15. Airflow channel; 111. Air outlet hole; 51. First end; 52. Second end; 53. First portion; 54. Second portion; 55. Second flexible sealing member; 61. First section; 62. Second section; 71. Heating wire; 72. First lead; 73. Second lead; 81. Transmission tube; 82. Wall hole; 83. Upper end; 84. Lower end; 101. First recess; 102. Central hole; 112. Sealing ring; 131. Insulating ring; 132. Electrode; 133. Air inlet hole; 134. Second wall hole; 1010. First holding element; 1110. Second holding element; 1011. Flow guide structure; 1012. Groove; 1013. First air hole; 1111. Second recess; 1112. Second air hole.

### DETAILED DESCRIPTION

Technical solutions in embodiments of this application are clearly and completely described below with reference to drawings in the embodiments of this application. Apparently, the described embodiments are a part rather than all of the embodiments of this application. All other embodiments obtained by a person of ordinary skill in the art based on the embodiments of this application without creative efforts shall fall within the protection scope of this application. Terms “first” and “second” herein are merely used for description, and cannot be construed as indicating or implying relative importance or implicitly indicating a quantity of indicated technical features. A term “and/or” herein describes only an association relationship for describing associated objects and represents that three relationships may exist. For example, A and/or B may represent the following three cases: only A exists, both A and B exist, and only B exists. In addition, a character “/” herein generally indicates an “or” relationship between the associated objects. In addition, “plurality of” herein indicates two or more than two.

An exemplary structure of an electronic atomization device 1000 is described in the following embodiments of this application.

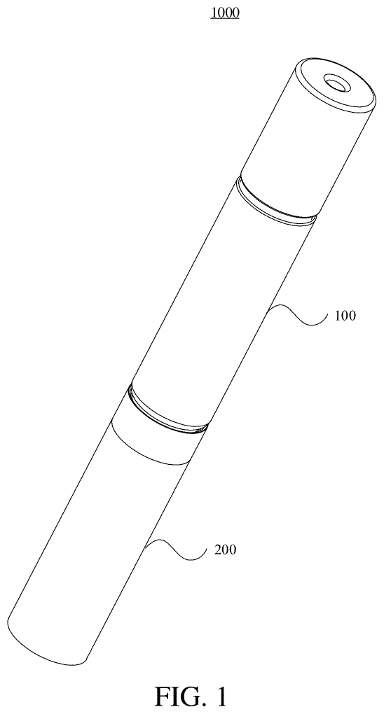

As shown in FIG. 1, the electronic atomization device 1000 provided in this application includes an atomizer 100 and a power supply mechanism 200 configured to supply power to the atomizer. The electronic atomization device 1000 may be used for medical or other purposes. The atomizer 100 may be a part of the split-type electronic atomization device 1000, and is configured to atomize a liquid substrate stored therein. The power supply mechanism 200 is electrically connected to the atomizer 100, and has a detachable battery mounted therein, to facilitate replacement by a user.

An exemplary structure of the atomizer 100 is described in the following embodiments of this application.

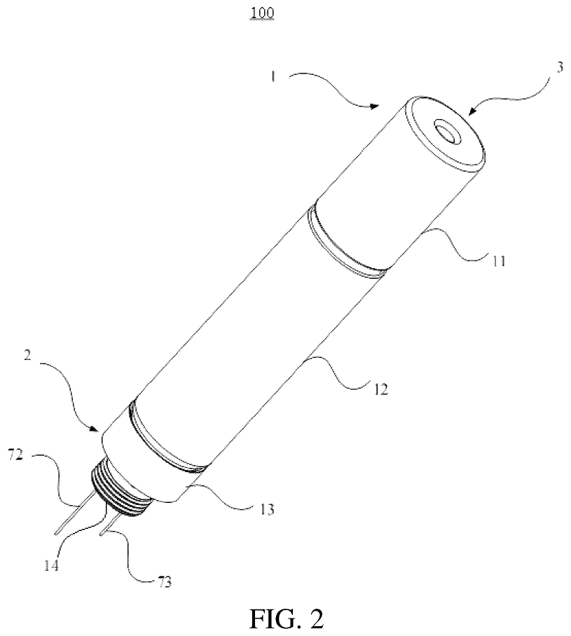

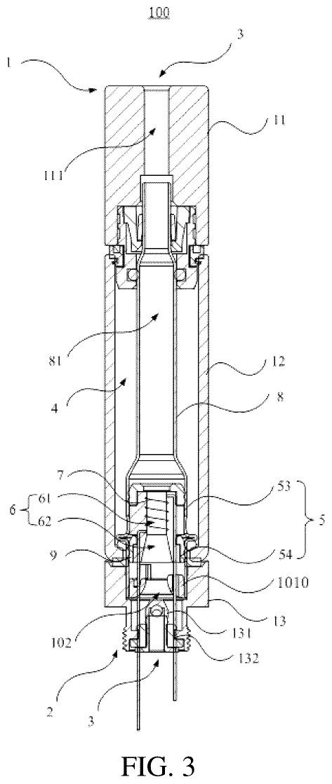

As shown in FIG. 2 and FIG. 3, the atomizer 100 includes a proximal end 1 and a distal end 2 facing away from each other in a longitudinal direction, an inhalation port 3, a liquid storage cavity 4, a porous body 5, a through hole 6, and a heating element 7.

The inhalation port 3 is located at the proximal end 1. The inhalation port 3 is in an air outlet direction of the atomizer 100, and a user inhales an aerosol formed through atomization of the liquid substrate through the inhalation port 3.

The liquid storage cavity 4 is configured to store the liquid substrate. The liquid substrate may be a liquid containing medicine or another active ingredient.

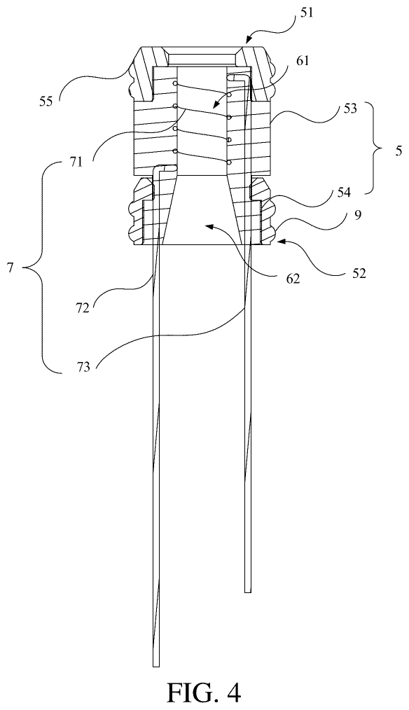

As shown in FIG. 3, the porous body 5 is in fluid communication with the liquid storage cavity 4 to receive or absorb at least part of the liquid substrate. As shown in FIG. 4, the porous body 5 includes a first end 51 close to the proximal end 1 and a second end 52 close to the distal end 2. The porous body 5 may be a porous ceramic material mainly prepared from a high-quality raw material such as emery, silicon carbide, and cordierite through molding and special high-temperature sintering process, which has a hole diameter and a high gas hole ratio, and has advantages such as high-temperature resistance, high-pressure resistance, acid resistance, alkali resistance, and organic medium corrosion resistance, good biological inertness, a controllable pore structure, a high porosity, a long service life, and good product regeneration performance. The porous body 5 may also be made of other different materials such as glass fiber.

As shown in FIG. 4, the through hole 6 runs through or extends to the second end 52 from the first end 51 of the porous body 5. The through hole 6 includes a first section 61 close to the first end 51 and a second section 62 close to the second end 52. A cross-sectional area of the second section 62 at the second end 52 is greater than a cross-sectional area thereof close to the first section 61. Therefore, a condensate formed from the aerosol that is formed through atomization of the liquid substrate after cooling can flow out toward the distal end 2 along an outer periphery of the second section 62, so as to avoid further impact on an atomization effect as a result of the porous body 5 being clogged by the condensate.

As shown in FIG. 4, a cross-sectional area of the first section 61 is substantially constant. For example, in this embodiment, the first section 61 may be arranged in a cylindrical shape with a consistent cross-sectional area. The cross-sectional area of the second section 62 gradually decreases in a direction toward the first section 61. For example, in this embodiment, the second segment 62 may be arranged in a shape of a horn mouth, and the cross-sectional area thereof gradually decreases in the direction toward the first section 61. Further, a length of the first section 61 is greater than a length of the second section 62. The length of the first section 61 is in a range of 4-8 mm, and/or the length of the second section 62 is in a range of 2-4 mm. For example, in some embodiments, the length of the first section 61 is 4 mm, and the length of the second section 62 is 2 mm. Alternatively, the length of the first section 61 is 6 mm, and the length of the second section 62 is 3 mm. Alternatively, the length of the first section 61 is 8 mm, and the length of the second section 62 is 4 mm, and so on.

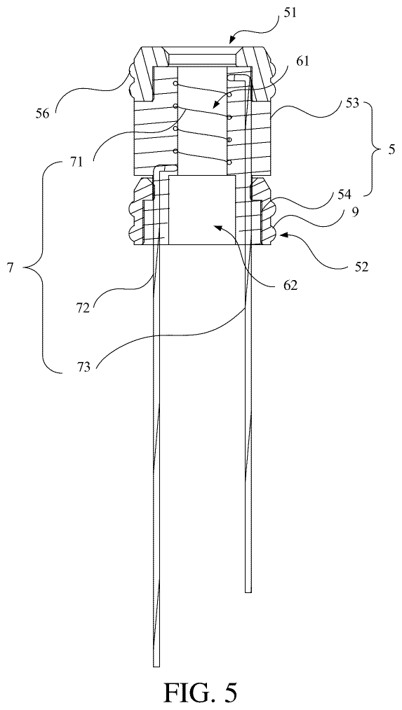

As shown in FIG. 5, in another embodiment, the cross-sectional area of the second section 62 is substantially constant. For example, the second section may be arranged in a cylindrical shape different from the horn mouth in the foregoing embodiment. In other words, the first section 61 is in a cylindrical shape having a consistent cross-sectional area, and the second section 62 is in a cylindrical shape having a cross-sectional area that is consistent but greater than the cross-sectional area of the first section 61.

In another embodiment, the first section 61 may also be referred to as a first sub-section, and the second section 62 may also be referred to as a second sub-section. A structure and a function of the first sub-section are the same as those of the first section 61, and a structure and a function of the second sub-section are the same as those of the second section 62.

As shown in FIG. 4, the heating element 7 is integrated on the porous body 5 and arranged adjacent to the through hole 6, so as to heat at least part of the liquid substrate of the porous body 5 to generate an aerosol. The heating element 7 is arranged to at least partially surround the first section 61 and avoid the second section 62. Therefore, the liquid substrate concentrates in the first section 61 of the through hole and is atomized to form the aerosol.

As shown in FIG. 4, the heating element 7 may specifically include a heating wire 71, and a first lead 72 and a second lead 73 respectively connected to two ends of the heating wire 71. The heating wire 71 is spirally arranged to wind at least part of an inner wall of the first end 51 of the porous body 5 and avoid the second end 52, so as to help sufficiently atomize the liquid substrate absorbed by the porous body 5. In another embodiment, the heating wire 71 may be arranged in a different form such as a grid shape, so as to help sufficiently heat and atomize a liquid substrate having different physical and chemical properties. The heating element 7 generates heat in an energized state, so as to atomize the liquid substrate seeped from outside of the porous body 5. The heating element is usually made of a metal wire (for example, a nickel-chromium alloy).

A combination of the porous body 5 and the heating element 7 may also be referred to as an atomization assembly, which is configured to atomize the liquid substrate to generate an aerosol.

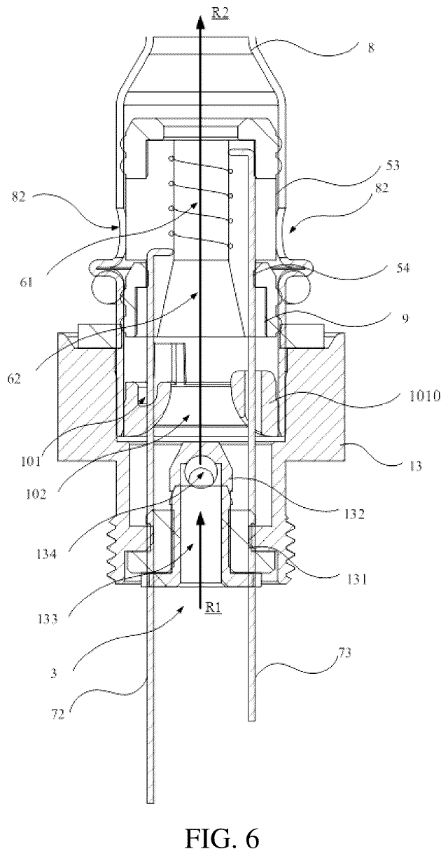

As shown in FIG. 3 and FIG. 6, the atomizer 100 may further include a first tubular element 8, and the porous body 5 may further include an elastic element 9. The first tubular element 8 at least partially extends within the liquid storage cavity 4 in the longitudinal direction of the atomizer 100. The porous body 5 is accommodated or retained in the first tubular element 8.

As shown in FIG. 4, further, the porous body 5 may include a first portion 53 and a second portion 54. The first portion 53 surrounds or defines the first section 61 of the through hole 6. The second portion 54 surrounds or defines the second section 62 of the through hole 6. The first portion 53 and the second portion 54 may be molded at a time through sintering or the like. A gap between an outer wall of a bottom end of the first portion 53 and an inner wall of the first tubular element 8 is within 0.2 mm. In this way, impact on seeping of the liquid substrate into the porous body 5 caused by negative pressure change in the liquid storage cavity 4 as a result of vent bubbles growing up in the gap between the outer wall of the first portion 53 and the inner wall of the first tubular element 8 and accumulating into a large bubble can be prevented.

As shown in FIG. 3 and FIG. 6, the elastic element 9 at least partially elastically abuts between the first tubular element 8 and the second portion 54. The first tubular element 8 is elastically coupled to the second portion 54 at least through the elastic element 9, to cause the porous body to be retained in the first tubular element 8. The elastic element 9 is pressed or compressed between the second portion 54 and the first tubular element 8 in a radial direction. Further, the first tubular element 8 is configured to define or surround a transmission tube 81. The transmission tube 81 is in communication with the proximal end 1 and the distal end 2 of the atomizer 100. Therefore, the aerosol in the porous body 5 formed through atomization can flow to the inhalation port 3 along an airflow path.

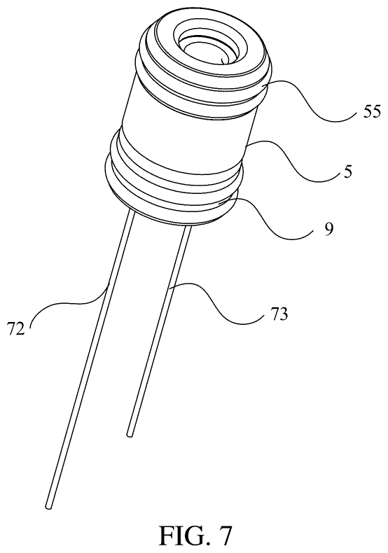

As shown in FIG. 4 and FIG. 7, in another embodiment, the elastic element 9 of the porous body 5 may be implemented as a first flexible sealing member. The first flexible sealing member is at least partially located between the second portion 54 and the first tubular element 8, to provide sealing therebetween. In this way, the porous body 5 can be easily fixed inside the first tubular element 8 without a displacement. The first flexible sealing member may be made of soft materials such as silica gel and rubber. Further, the porous body 5 may further include a second flexible sealing member 55. The second flexible sealing member 55 is at least partially located between the first portion 53 and the first tubular element 8, to provide sealing therebetween. The second flexible sealing member 55 may also be made of soft materials such as silica gel and rubber. The first flexible sealing member and the second flexible sealing member 55 may be engaged with each other to avoid poor assembly situations such as dragging, turning up, and detaching during fitting of the porous body 5 into the first tubular element 8.

As shown in FIG. 2 and FIG. 3, the atomizer 100 may further include a first holding element 1010. The first holding element 1010 is located between a port of the second section 62 at the second end 52 and the distal end 2, so as to hold an aerosol condensate. The first holding element 1010 is at least partially opposite or aligned with the through hole 6 in the longitudinal direction of the atomizer 100. A first cavity 101 is provided on a surface of the first holding element 1010 facing the through hole 6 and/or the porous body 5, so as to accommodate or retain the to-be-held aerosol condensate, thereby avoiding corrosion of another assembly due to long-term liquid leakage. A central hole 102 is further provided in a central area of the first holding element 1010 facing the through hole 6 and/or the porous body 5. A cross-sectional area of the central hole 102 gradually increases in a direction away from the through hole 6 and/or the porous body 5. For example, the central hole 102 may be in a shape of a horn mouth, a cone, or the like. In this way, it is convenient for the condensate that spilling out of the first recess 101 to flow downward along the central hole 102, thereby preventing blocking of the central hole 102 of the first holding element 1010.

As shown in FIG. 2 and FIG. 3, the atomizer 100 may further include a suction nozzle assembly 11, a housing 12, and a base assembly 13. The suction nozzle assembly 11 is configured to define the proximal end 1 of the atomizer 100, and has an air outlet hole 111 provided therein. The air outlet hole 111 is in communication with the transmission tube 81, so that the aerosol flows out toward the proximal end 1 of the atomizer 100. The housing 12 is connected to an other end of the suction nozzle assembly 11 away from the proximal end 1, and the base assembly 13 is connected to an other end of the housing 12 away from the suction nozzle assembly 11.

An inner wall of the housing 12 and an outer wall of the first tubular element 8 define the liquid storage cavity 4, and two ends of the liquid storage cavity 4 are respectively blocked by the suction nozzle assembly 11 and the base assembly 13, to form a hermetic space. The housing 12 may be made of a transparent material, so as to help the user observe a level of the liquid substrate therein. The liquid substrate may be supplemented after being exhausted.

A plurality of wall holes 82 may be provided on an outer periphery of the first tubular element 8 abutting against the second portion 54 of the porous body 5. The liquid substrate in the liquid storage cavity 4 may seep to the porous body 5 through the plurality of wall holes 82, so as to be further atomized to form an aerosol. For example, in this embodiment, a quantity of the wall holes 82 is two, and respectively correspond to a radial direction of the second portion 54 of the porous body 5.

As shown in FIG. 3, an insulating ring 131 is arranged on an inner wall of the base assembly 13, and an electrode 132 is sleeved on an inner wall of the insulating ring 131. The first lead 72 and the second lead 73 may be respectively connected to the electrode 132 and the electrically conductive base assembly 13, so as to generate heat to atomize the liquid substrate to form an aerosol after being energized. The electrode 132 and the base assembly 13 are configured to be electrically connected to a positive electrode and a negative electrode of the power supply mechanism 200. The insulating ring 131 is configured to insulate the electrode 132 from the base assembly 13, to prevent a short circuit.

The atomizer 100 further includes an air inlet 14 and an airflow channel 15 located between the air inlet 14 and the inhalation port 3. The air inlet 14 is located at the distal end 2. The air inlet 14 is in an air inlet direction of the atomizer 100.

The electrode 132 is arranged in a shape of a hollow ring, and an inner wall thereof is configured to define an air inlet hole 133. Further, at least one second wall hole 134 is provided on a side wall of the electrode 132, so that air entering the air inlet hole 133 enters the atomization assembly through the second wall hole 134.

The air inlet 14, the inhalation port 3, and the airflow channel 15 are arranged to define an airflow path from the air inlet 14 to the inhalation port 3 through the atomization assembly, to transmit the aerosol to the inhalation port 3. In other words, during use of the atomizer 100, inhalation is performed at the suction nozzle assembly 11 to generate negative pressure in the housing 12, external air enters the air inlet hole 133 of the electrode 132 through the air inlet 14, and then enters the central hole 102 of the first holding element 1010 through the second wall hole 134 of the electrode 132 along a path shown by an arrow R2 in FIG. 6. The air further flows along a path shown by an arrow R1 in FIG. 6, and then carries the aerosol generated by the porous body 5, which sequentially passes through the transmission tube 81 of the first tubular element 8, and is inhaled at the air outlet hole 111 of the suction nozzle assembly 11. In this way, a complete airflow channel 15 is formed.

Based on the above, in this application, the through hole 6 of the atomizer 100 is arranged to run through or extend to the second end 52 from the first end 51 of the porous body 5, the through hole 6 includes the first section 61 close to the first end 51 and the second section 62 close to the second end 52, and the cross-sectional area of the second section 62 at the second end 52 is greater than the cross-sectional area thereof close to the first section 61. Therefore, when the aerosol inside the porous body 5 is condensed, the aerosol can flow out downward along the outer periphery of the second section 62 of the through hole, so as to avoid impact on an atomization effect as a result of the through hole 6 in the porous body 5 being clogged.

A liquid substrate in an existing electronic atomizer configured to be atomized is usually in a grease or paste form, and usually has a viscosity in a range of 100000-1000000 pa·s at a normal temperature. After the electronic atomizer is used, in which the liquid substrate is atomized, a relatively large quantity of condensates remain in an internal atomization assembly, for example, the porous body. If no special structure is arranged to store or recycle the condensates, the porous body may be clogged in a normal temperature.

To resolve the technical problem, another embodiment of this application discloses an electronic atomization device 1000. As shown in FIG. 1, FIG. 1 is a three-dimensional schematic structural diagram of an electronic atomization device according to an embodiment of this application. The electronic atomization device 1000 provided in this application includes an atomizer 100 and a power supply mechanism 200 configured to supply power to the atomizer. The electronic atomization device 1000 may be used for medical or other purposes. The atomizer 100 may be a part of the split-type electronic atomization device 1000, and is configured to atomize a liquid substrate stored therein. The power supply mechanism 200 is electrically connected to the atomizer 100, and has a detachable battery mounted therein, to facilitate replacement by a user.

An exemplary structure of the atomizer 100 is described in the following embodiments of this application.

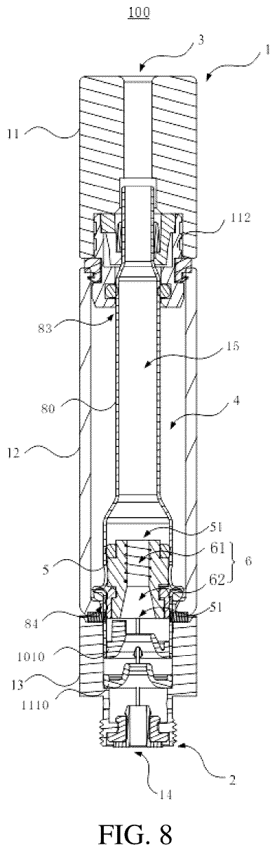

As shown in FIG. 2 and FIG. 8, FIG. 2 is a three-dimensional schematic structural diagram of an atomizer of the electronic atomization device shown in FIG. 1. FIG. 8 is a schematic structural cross-sectional view of the atomizer shown in FIG. 2. The atomizer 100 includes the proximal end 1 and the distal end 2 facing away from each other in the longitudinal direction, the inhalation port 3, the liquid storage cavity 4, the porous body 5, the heating element 7, and the first holding element 1010. The atomizer 100 further includes the second holding element 1110, the air inlet 14, a second tubular element 80, the suction nozzle assembly 11, the housing 12, the base assembly 13, and the airflow channel 15.

The inhalation port 3 is located at the proximal end 1. The air inlet 14 is located at the distal end 2. The suction nozzle assembly 11 is configured to define the proximal end 1 of the atomizer 100. The base assembly 13 is configured to define the distal end 2 of the atomizer 100. A cavity is provided inside the suction nozzle assembly 11 to be defined as the inhalation port 3. A cavity is further provided inside the suction nozzle assembly 11 to be defined as the air inlet 14. The housing 12 is connected to one end of the suction nozzle assembly 11 away from the proximal end 1, and the base assembly 13 is connected to an other end of the housing 12 away from the suction nozzle assembly 11.

The liquid storage cavity 4 is configured to store the liquid substrate. The liquid substrate may be a liquid containing medicine or another liquid substrate, which usually have different physical and chemical shapes. For example, some liquid substrates have a relatively high viscosity, and some liquid substrates have a relatively low viscosity.

The second tubular element 80 is arranged inside the housing 12, with one end thereof being accommodated inside the suction nozzle assembly 11 and an other end being accommodated inside the base assembly 13. An inner wall of the second tubular element 80 is configured to define the airflow channel 15. The airflow channel 15 is located between the air inlet 14 and the inhalation port 3.

The inner wall of the housing 12 and an outer wall of the second tubular element 80 define the liquid storage cavity 4. A sealing ring 111 is arranged inside the suction nozzle assembly 11. The sealing ring 111 is arranged around an outer periphery of the second tubular element 80, with one end being accommodated at one end of the suction nozzle assembly 11 away from the proximal end 1 and an other end extending into the housing 12 and abutting against the inner wall of the housing 12, so that abutment is formed against the upper end 83 of the second tubular element 80, thereby preventing unnecessary displacement. A bottom end of the housing 12 is in a bent shape, and an edge thereof extends to a lower end 84 of the second tubular element 80, to support an outer periphery of the lower end 84 of the second tubular element 80, so as to fix the outer periphery. Therefore, the outer wall of the second tubular element 80 and the inner wall of the housing 12 form a hermetic liquid storage space 4. The housing 12 may be made of transparent glass, a resin, or the like, so as to help the user observe a level of the liquid substrate therein. The liquid substrate may be supplemented after being exhausted.

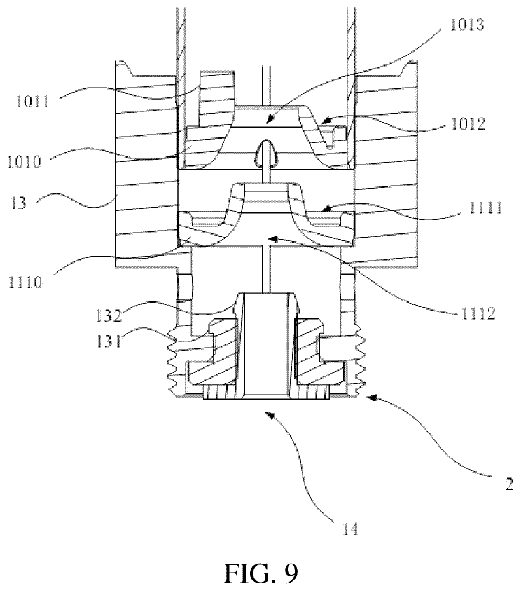

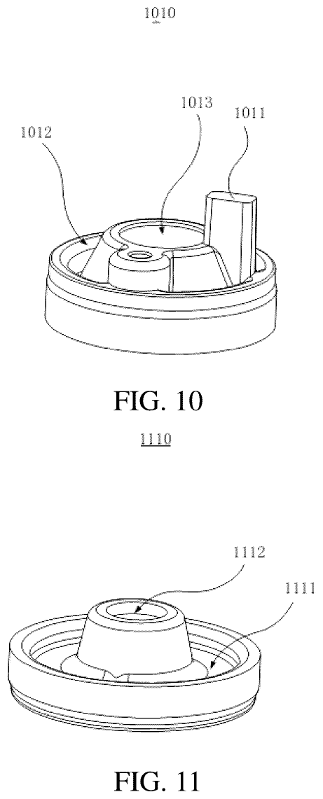

Further referring to FIG. 9 and FIG. 10, FIG. 9 is a partial schematic enlarged view of the atomizer shown in FIG. 8, and FIG. 10 is a three-dimensional schematic structural diagram of the first holding element of the atomizer shown in FIG. 8. The first holding element 1010 is located between the porous body 5 and the distal end 2, so as to hold the aerosol condensate in the through hole 6. The first holding element 1010 is provided with at least one flow guide structure 1011. After the aerosol that is formed through the atomization of the liquid substrate is cooled, the aerosol easily forms a condensate on the outer periphery of the porous body 5. The flow guide structure 1011 is arranged to extend from the first holding element 1010 toward the through hole 6, and is configured to guide the aerosol condensate in the through hole 6 toward the first holding element 1010. In this embodiment, the first holding element 1010 is specifically arranged on an inner wall of the second tubular element 80 close to the lower end 84. In another embodiment, the first holding element 1010 may be arranged inside the base assembly 13. In this embodiment, a quantity of the at least one flow guide structure 1011 is one. When the condensate has a relatively low viscosity and relatively strong mobility, only one flow guide structure 1011 may be arranged. In another embodiment, the quantity of the at least one flow guide structure 1011 may be a plurality, for example, two, three, or four. The plurality of flow guide structures 1011 are arranged at intervals in a longitudinal direction of the first holding element 1010. When the condensate has a relatively high viscosity and relatively poor mobility, a plurality of flow guide structures 1011 may be arranged, so as to improve guiding efficiency.

The flow guide structure 1011 is constructed as a column shape extending from the first holding element 1010 toward the through hole 6. For example, the flow guide structure 1011 may be in a shape of a square column, a circular column, an elliptic column, or the like. In some embodiments, a cross-sectional area of the flow guide structure 1011 may be consistent. In another embodiment, the cross-sectional area of the flow guide structure 1011 may be set to gradually decrease in a direction toward the through hole 6, so as to help guide the condensate to flow rapidly. In this embodiment, the flow guide structure 1011 is in a shape of a square cylinder with a consistent cross-sectional area.

A projection of the flow guide structure 1011 in the longitudinal direction of the atomizer 100 is partially located in the through hole 6. Because the condensate is partially suspended in the through hole 6 when flowing along an inner wall of the porous body 5, the flow guide structure 1011 is arranged such that the projection in the longitudinal direction of the atomizer 100 is partially located in the through hole 6, so as to hold the condensate extending to the through hole 6.

In this embodiment, the flow guide structure 1011 is not in contact with the porous body 5, so as to form a gap. A gap is maintained between the flow guide structure 1011 and the second end 52 of the through hole 6 in the longitudinal direction of the atomizer 100, to define a capillarity channel, so as to adsorb the aerosol condensate from the second end 52 of the through hole 6 to the flow guide structure 1011 through a capillarity action. The gap between the flow guide structure 1011 and the second end 52 of the through hole 6 is in a range of 0.2-2 mm. For example, the gap is 0.2 mm, 0.3 mm, 0.5 mm, 0.8 mm, 1.0 mm, 1.5 mm, 1.8 mm, or 2.0 mm. In another embodiment, the flow guide structure 1011 may be arranged to be directly in contact with the porous body 5, that is, no gap exists between the flow guide structure 1011 and the porous body 5. In this way, the condensate can directly flow along the flow guide structure 1011. For example, when the liquid substrate has a relatively high viscosity, the flow guide structure 1011 may be arranged to be directly in contact with the porous body 5.

A groove 1012 is defined on a surface of the first holding element 1010 adjacent to the porous body 5, so as to accommodate or retain the aerosol condensate. The condensate formed by the aerosol flows out in a direction toward the distal end 2, and flows into the groove 1012 under guidance of the flow guide structure 1011, so as to avoid further impact on an atomization effect as a result of the porous body 5 being clogged by the condensate.

The first holding element 1010 is provided with a first air hole 1013 that is provided substantially coaxially with the through hole 6. In addition, a diameter of at least part of the first air hole 1013 is less than a diameter of at least part of the through hole 6. The first air hole 1013 is provided for air to enter the through hole 6 through the first air hole 1013 during use. In this way, when excessive condensates in the groove 1012 overflow, the condensates may flow downward along the first air hole 1013, to prevent the first air hole 1013 of the first holding element 1010 from being clogged. A cross-sectional area of the first air hole 1013 gradually increases in a direction away from the porous body 5. For example, the first air hole 1013 may be in a shape of a horn mouth, a cone, or the like. The shape such as the horn mouth or the cone helps accelerate flowing of the condensate.

The first holding element 1010 is further provided with two avoidance grooves, and the first lead 72 and the second lead 73 extend into the base assembly 13 through the two avoidance grooves respectively.

Still referring to FIG. 8, FIG. 9 and FIG. 11, FIG. 11 is a three-dimensional schematic structural diagram of the second holding element of the atomizer shown in FIG. 8. The second holding element 1110 is located between the first holding element 1010 and the distal end 2, so as to hold the aerosol condensate that flows out through the first air hole 1013. The second holding element 1110 is spaced apart from the first holding element 1010 in the longitudinal direction of the atomizer 100. In this embodiment, the second holding element 1110 is specifically arranged inside the base assembly 13. In another embodiment, the second holding element 1110 may be arranged on an inner wall of the second tubular element 80 close to the lower end 84. In other words, the first holding element 1010 and the second holding element 1110 are both arranged on the inner wall of the second tubular element 80 close to the lower end 84, or the first holding element 1010 and the second holding element 1110 are both arranged inside the base assembly 13.

In some embodiments, a second cavity 1111 is defined on a surface of the second holding element 1110 adjacent to the first holding element 1010, so as to accommodate or retain the aerosol condensate. The condensate formed by the aerosol flows out in the direction toward the distal end 2, and flows into the groove 1012 under guidance of the flow guide structure 1011. when the condensate in the groove 1012 overflows, the condensate further flows in a circumferential direction of the first air hole 1013. The second cavity 1111 is provided to be aligned with a side of the first holding element 1010 facing the distal end. In this way, the condensate flowing out through the first air hole 1013 is held by the second cavity 1111, which provides double guarantee for preventing the porous body 5 from being clogged by the condensate.

The second holding element 1110 is provided with a second air hole 1112 that is provided substantially coaxially with the first air hole 1013. In addition, a diameter of at least part of the second air hole 1112 is less than a diameter of at least part of the first air hole 1013. The second air hole 1112 is provided for air to enter the first air hole 1013 through the second air hole 1112 and then enter the through hole 6. In this way, when excessive condensates in the groove 1012 overflow, the condensates may flow downward to the second cavity 1111 along the first air hole 1013, to prevent the first air hole 1013 of the first holding element 1010 from being clogged. A cross-sectional area of the second air hole 1112 gradually increases in a direction away from the first holding element 1010. For example, the second air hole 1112 may be in a shape of a horn mouth, a cone, or the like. The shape such as the horn mouth or the cone helps accelerate flowing of the condensate.

The second holding element 1110 is also provided with two avoidance portions. The two avoidance portions are in one-to-one alignment with the two avoidance grooves provided on the first holding element 1010. The first lead 72 and the second lead 73 extend into the base assembly 13 through the two avoidance grooves and the two avoidance portions respectively.

As shown in FIG. 8 and FIG. 9, an insulating ring 131 is arranged on an inner wall of the base assembly 13, and an electrode 132 is sleeved on an inner wall of the insulating ring 131. The first lead 72 and the second lead 73 may be respectively connected to the electrode 132 and the electrically conductive base assembly 13, so as to generate heat to atomize the liquid substrate to form an aerosol after being energized. The electrode 132 and the base assembly 13 are configured to be electrically connected to a positive electrode and a negative electrode of the power supply mechanism. The insulating ring 131 is configured to insulate the electrode 132 from the base assembly 13, to prevent a short circuit.

Based on the above, in this application, the first holding element 1010 is arranged in the atomizer 100, to hold the aerosol condensate in the through hole 6. In addition, the first holding element 1010 is provided with at least one flow guide structure 1011, and the flow guide structure 1011 is arranged to extend from the first holding element 1010 toward the through hole 6, and can guide the aerosol condensate in the through hole 6 toward the first holding element 1010, thereby preventing the through hole from being clogged.

Different from the prior art, in the atomizer provided in this application, the first holding element is arranged to hold the aerosol condensate in the through hole, the first holding element is provided with at least one flow guide structure, the flow guide structure is arranged to extend from the first holding element toward the through hole, and the flow guide structure can guide the aerosol condensate in the through hole toward the first holding element, thereby preventing the through hole from being clogged.

The foregoing descriptions are merely the embodiments of this application, and are not intended to limit the patent scope of this application. All equivalent structure or process changes made according to the content of the specification and the drawings of this application or direct or indirect application in other related arts shall fall within the protection scope of this application.

1. An atomizer, comprising a proximal end and a distal end facing away from each other in a longitudinal direction, and further comprising:
an inhalation port, located at the proximal end;
a liquid storage cavity, configured to store a liquid substrate;
a porous body, in fluid communication with the liquid storage cavity to receive or absorb at least part of the liquid substrate, wherein the porous body comprises a first end close to the proximal end and a second end close to the distal end;
a through hole, running through or extending to the second end from the first end of the porous body, wherein the through hole comprises a first section close to the first end and a second section close to the second end, and a cross-sectional area of the second section at the second end is greater than a cross-sectional area thereof close to the first section; and
a heating element, integrated on the porous body and arranged adjacent to the through hole, so as to heat at least part of the liquid substrate of the porous body to generate an aerosol, wherein the heating element is arranged to at least partially surround the first section and avoid the second section.

2. The atomizer according to claim 1, wherein the cross-sectional area of the first section is substantially constant.

3. The atomizer according to claim 1, wherein the cross-sectional area of the second section gradually decreases in a direction toward the first section.

4. The atomizer according to claim 1, wherein a length of the first section is greater than a length of the second section.

5. The atomizer according to claim 1, further comprising:
a first tubular element, at least partially extending within the liquid storage cavity in the longitudinal direction of the atomizer,
wherein the porous body is accommodated or retained in the first tubular element.

6. The atomizer according to claim 5, wherein the porous body comprises:
a first portion, surrounding or defining the first section of the through hole;
a second portion, surrounding or defining the second section of the through hole; and
an elastic element, at least partially elastically abutting between the first tubular element and the second portion,
wherein the first tubular element is elastically coupled to the second portion at least through the elastic element, to cause the porous body to be retained in the first tubular element.

7. The atomizer according to claim 1, further comprising:
a first holding element, located between the porous body and the distal end and configured to carry an aerosol condensate.

8. The atomizer according to claim 7, wherein the first holding element is provided with at least one flow guide structure, and the flow guide structure is arranged to extend from the first holding element toward the through hole, and is configured to guide an aerosol condensate in the through hole toward the first holding element.

9. The atomizer according to claim 8, wherein the flow guide structure is constructed as a column shape extending from the first holding element toward the through hole.

10. The atomizer according to claim 7, further comprising a second holding element located between the first holding element and the distal end, wherein the second holding element and the first holding element are spaced apart from each other in the longitudinal direction of the atomizer.

11. The atomizer according to claim 7, wherein the first holding element is at least partially opposite or aligned with the through hole in the longitudinal direction of the atomizer.

12. An atomizer, comprising a proximal end and a distal end facing away from each other in a longitudinal direction, and further comprising:
a liquid storage cavity, configured to store a liquid substrate;
a first tubular element, at least partially extending within the liquid storage cavity in the longitudinal direction of the atomizer;
a heating element, located in the first tubular element and configured to heat the liquid substrate to generate an aerosol;
a porous body, located in the first tubular element and constructed to extend in an axial direction of the first tubular element, wherein the porous body comprises a first portion and a second portion arranged in sequence in the axial direction of the first tubular element, the first portion at least partially surrounding the heating element, and the second portion avoids the heating element; and
an elastic element, at least partially elastically abutting between the first tubular element and the second portion, wherein the first tubular element is elastically coupled to the second portion at least through the elastic element, to cause the porous body to be retained in the first tubular element.

13. The atomizer according to claim 12, further comprising:
a through hole, running through or extending to the second portion from the first portion of the porous body, wherein the through hole comprises a first sub-section close to the first portion and a second sub-section close to the second portion; and a cross-sectional area of the second sub-section at the second portion is greater than a cross-sectional area thereof close to the first sub-section.

14. An atomizer, comprising a proximal end and a distal end facing away from each other in a longitudinal direction, and further comprising:
an inhalation port, located at the proximal end;
a liquid storage cavity, configured to store a liquid substrate;
a porous body, in fluid communication with the liquid storage cavity to receive or absorb at least part of the liquid substrate, wherein the porous body comprises a first end close to the proximal end and a second end close to the distal end;
a through hole, running through or extending to the second end from the first end of the porous body, wherein the through hole comprises a first section close to the first end and a second section close to the second end, and at least part of a cross-sectional area of the second section is greater than a cross-sectional area of the first section; and
a heating element, integrated on the porous body and arranged adjacent to the through hole, so as to heat at least part of the liquid substrate of the porous body to generate an aerosol, wherein the heating element is arranged to avoid the second section.

15. An electronic atomization device, comprising an atomizer configured to atomize a liquid substrate to generate an aerosol and a power supply mechanism configured to supply power to the atomizer; wherein the atomizer comprises the atomizer according to claim 1.
